(19) United States
(12) Patent Application Publication
(10) Pub. No.: US 2022/0211149 A1
(43) Pub. Date: Jul. 7, 2022

(54) Multipurpose Floating Weather Canopy

(71) Applicant: JOHN Adams LEE, Alvin, TX (US)

(72) Inventor: JOHN Adams LEE, Alvin, TX (US)

(21) Appl. No.: 17/141,250

(22) Filed: Jan. 5, 2021

(51) Int. Cl. A45B 23/00; B64B 1/66; B64B 1/50

(52) U.S. Cl. CPC A45B 23/00; B64B 1/66; A45B 2023/0093; A45B 2023/0006; B64B 1/50

(57) ABSTRACT

The present disclosure proposes a multipurpose floating weather canopy. The multipurpose floating weather canopy comprises of an inner gas tight hollow body, an outer gas tight hollow body, a mesh and plurality of ropes. The multipurpose floating weather canopy aids to shield and protect homes, vehicles and thereof from adverse effects of weather conditions such as sunlight and snow. The size of the multipurpose floating weather canopy is variable based on object size that includes either house or vehicle or factory and thereof. The multipurpose floating weather canopy can be manufactured with required mesh material to protect from heat or snow based on the weather condition.

### FIELD OF INVENTION

The present disclosure generally relates to the technical field of shading devices, and in specific relates to a multipurpose floating weather canopy that aids to shield and protect homes, vehicles and thereof from adverse effects of weather conditions.

### BACKGROUND OF THE INVENTION

Various types of pollutions are rapidly increasing at a global level, thereby leading to an increase in temperatures during summers, reduction in temperatures and snowfall in winters as well as storms in rainy seasons. Irrespective of the season, weather has become very unpredictable. Such extreme weather conditions often challenge humans and cause inconvenience in daily routine.

Snow is caused by a process called precipitation in the Earth's atmosphere. It creates crystalline ice so that snowflakes fall from clouds in granular form. There are various forms of snow and it depends on the way it accumulates, melts, re-freezes and the rate at which it falls. Sometimes, snow combines with wind and rain making it even more dangerous. Snow affects human transport, buildings and other infrastructure.

People residing in countries that are located away from the equator often face difficulties in removing snow deposits on their homes, vehicles and thereof. People often maintain snow removal kits and snow covers for homes and vehicles. In recent years, the snow has become more important in the news with winters becoming the coldest for 100 years, and in recent winters the snow has been inches deep.

Similarly, one such extreme weather is elevated temperatures during summers. Year by year, the temperatures have been increasing along with global warming. It is essential to stay in shade and hydrated during hot weather. It is very important to safeguard against hot weather since it is fatal to people. During such extreme conditions, people often refrain from going outdoors, where vehicles and homes need to be protected from exposure to extreme heat. Conventionally, air conditioners are utilized to cool houses during extreme heat and vehicles are placed in parking space or shaded regions to protect from heat. However, air conditioners lead to wear of components and further may shut down due to consistent working.

In existing technology, a sunshade is formed using two sheets of a tough, yet flexible material which have been cut to an appropriate shape and size, and sealed together at the edges to form a flat, balloon-like structure. Pluralities of interconnecting flow channels or buoyant cells are stitched into the sheets to enable the structure to retain its shape without bulging. A conventional fill valve is provided for filling the space between the sheets with helium gas or another suitable gas. The shade is anchored above a selected surface using cables or other flexible connectors. The sunshade shields the individual from the sun. However, there is a need for a canopy structure that protects houses and vehicles from adverse weather conditions.

In general, snow covers or plastic tarps are utilized to cover houses from snowfall. Shovels are also utilized to remove snow deposits over houses and snow removal kits are utilized for removing snow deposits over vehicles. The plastic tarps are prone to ultraviolet breakdown when exposed to ultraviolet light. Further, removing snow deposits using shovels is tiresome and time-consuming.

Therefore, there is a need for a canopy structure that protects homes, vehicles and other exterior objects from adverse weather conditions. A canopy structure that is floatable, inflatable, and easily deployable is the need of the hour. There is a need for a canopy structure that enables easy cleaning and easy removal of snow. A canopy structure that enables easy snow removal and protects from snow and heat is required. A canopy structure is required that can be fastened to any object and manufactured in various sizes. There is a need for a canopy that protects objects from adverse weather conditions and is available at optimal cost.

### SUMMARY OF THE INVENTION

The present discussion includes a number of different methods and apparatus useful in, among other things, to shield and protect homes, vehicles and thereof from adverse effects of weather conditions.

According to an aspect, the invention provides a multipurpose floating weather canopy. The multipurpose floating weather canopy comprises of an inner gas tight hollow body, an outer gas tight hollow body, a mesh and plurality of ropes. The multipurpose floating weather canopy aids to protect exterior objects from adverse weather conditions such as sunlight or snow.

The inner gas tight hollow body is configured to float above an object. The inner gas tight hollow body is either in spherical or discoidal or cubical or cuboidal or triangular prism shape. The outer gas tight hollow body is configured to surround the inner gas tight hollow body with a certain offset. The outer gas tight hollow body is configured to float along with the inner gas tight hollow body and is extended with a plurality of fastening guides on its peripheral surface. In specific, the outer gas tight hollow body is in either elliptical or circular or rectangular shape.

The outer gas tight hollow body and the inner gas tight hollow body are inflated with gases that are lighter than air and float together to protect the object from extreme weather such as snow and sunlight. In specific, the outer gas tight hollow body and the inner gas tight hollow body are inflated with helium gas. The inner gas tight hollow body and the outer gas tight hollow body each comprise at least one valve that aids to retain the helium gas inside them.

The mesh is connected in between the inner gas tight hollow body and the outer gas tight hollow body. The mesh is configured with plurality of mesh threads to protect the object from extreme weather conditions. The mesh is made of either thermally insulating materials or other materials that protect from sunlight or snow and enable easy cleaning. In specific, the area of the mesh is limited to maintain the optimal cost of the multipurpose floating weather canopy.

The plurality of ropes are peripherally connected to the outer gas tight hollow body through the plurality of fastening guides. The plurality of ropes are extended to the ground for fastening and are configured to pass through the plurality of fastening guides and enable fastening of the multipurpose floating weather canopy. In specific, the plurality of ropes extended are fastened to the ground that contains a strong basement which contains either a temporarily deployed structure or a permanent deployed structure. The plurality of ropes extended are fastened to the strong basement using additional fastening elements.

The multipurpose floating weather canopy is designed based on object size that includes either house or vehicle or factory and thereof. The size of the multipurpose canopy can be varied based on the requirement and size of the object to be protected. The multipurpose floating weather canopy can be manufactured with required mesh material to protect from heat or snow based on the weather conditions.

Further, objects and advantages of the present invention will be apparent from a study of the following portion of the specification, the claims, and the attached drawings.

### DESCRIPTION OF DRAWINGS

The accompanying drawings, which are incorporated in and constitute a part of the specification, illustrate an embodiment of the invention, and, together with the description, serve to explain the principles of the invention.

FIG. 1A depicts a top view of a multipurpose floating weather canopy according to one embodiment of the present invention.

FIG. 1B depicts an isometric view of a multipurpose floating weather canopy according to one embodiment of the present invention.

FIG. 2A illustrates an exemplary use case of a multipurpose floating weather canopy fastened to a house according to one embodiment of the present invention.

FIG. 2B illustrates an exemplary use case of a multipurpose floating weather canopy fastened to a vehicle according to one embodiment of the present invention.

FIG. 2C illustrates an exemplary use case of a multipurpose floating weather canopy fastened to concrete blocks according to one embodiment of the present invention.

### DETAILED DESCRIPTION OF DRAWINGS

The following detailed description, which references and incorporates the figures, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

The present disclosure has been made with a view towards solving the problem with the prior art described above, and it is an object of the present invention to provide a multipurpose floating weather canopy that aids to shield and protect homes, vehicles and thereof from adverse effects of weather conditions.

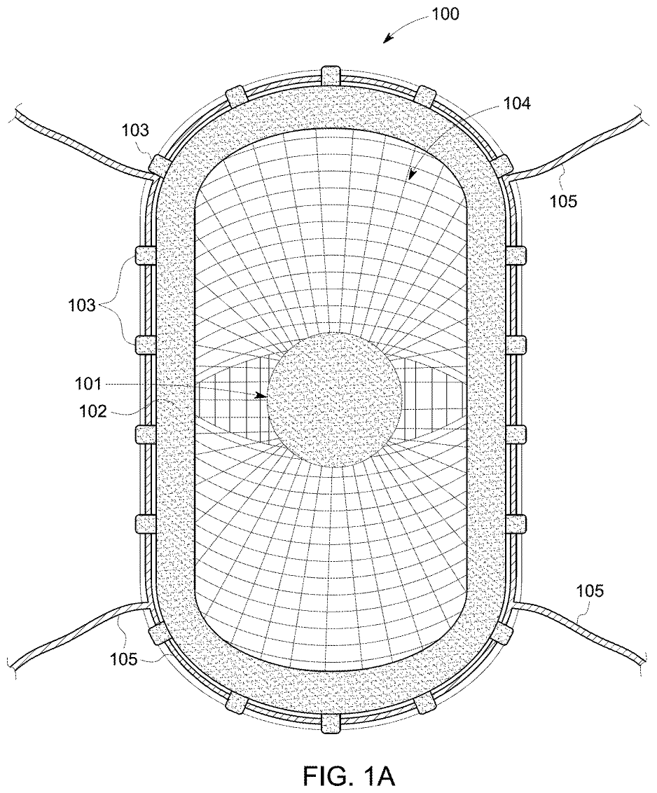

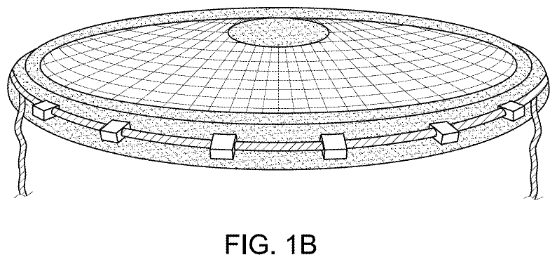

According to an exemplary embodiment of the invention, FIG. 1A and FIG. 1B refer to different views of a multipurpose floating weather canopy 100. The multipurpose floating weather canopy 100 comprises of an inner gas tight hollow body 101, an outer gas tight hollow body 102, a mesh 104 and plurality of ropes 105. The multipurpose floating weather canopy 100 aids to protect exterior objects from adverse weather conditions such as sunlight or snow.

The inner gas tight hollow body 101 is configured to float above an object. The inner gas tight hollow body 101 is either in spherical or discoidal or cubical or cuboidal or triangular prism shape. The outer gas tight hollow body 102 is configured to surround the inner gas tight hollow body 101 with a certain offset. The outer gas tight hollow body 102 is configured to float along with the inner gas tight hollow body 101 and is extended with plurality of fastening guides 103 on its peripheral surface. The plurality of fastening guides are positioned at uniform distances on the peripheral surface of the outer gas tight hollow body 102. In specific, the outer gas tight hollow body 102 is in either elliptical or circular or rectangular shape.

The outer gas tight hollow body 102 and the inner gas tight hollow body 103 are inflated with gases that are lighter than air and float together to protect the object from extreme weather such as snow and sunlight. In specific, the inner gas tight hollow body 101 and the outer gas tight hollow body 102 are inflated with helium gas. The inner gas tight hollow body 101 and the outer gas tight hollow body 102 each comprise at least one valve that aids to retain the helium gas inside them.

The mesh 104 is connected in between the inner gas tight hollow body 101 and the outer gas tight hollow body 102. The mesh 104 is configured with plurality of mesh threads to protect the object from extreme weather conditions. The mesh 104 is made of either thermally insulating materials or other materials that protect from sunlight or snow and enable easy cleaning. In specific, the area of the mesh 104 is limited to maintain the optimal cost of the multipurpose floating weather canopy. The mesh 104 is a multi-layered mesh that is formed using different patterns for each layer.

The plurality of ropes 105 are peripherally connected to the outer gas tight hollow body 102 through the plurality of fastening guides 103. The plurality of ropes 105 are extended to the ground for fastening and are configured to pass through the plurality of fastening guides 103. The fastening guides 103 enable fastening of the multipurpose floating weather canopy 100 to the object. In specific, the plurality of ropes 105 extended are fastened to the ground that contains a strong basement which is either a temporarily deployed structure or a permanently deployed structure. The plurality of ropes 105 extended are fastened to the strong basement using additional fastening elements.

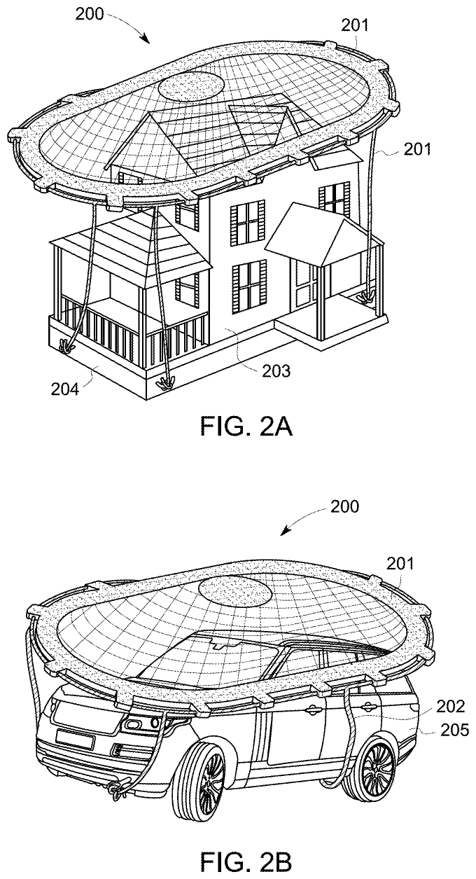

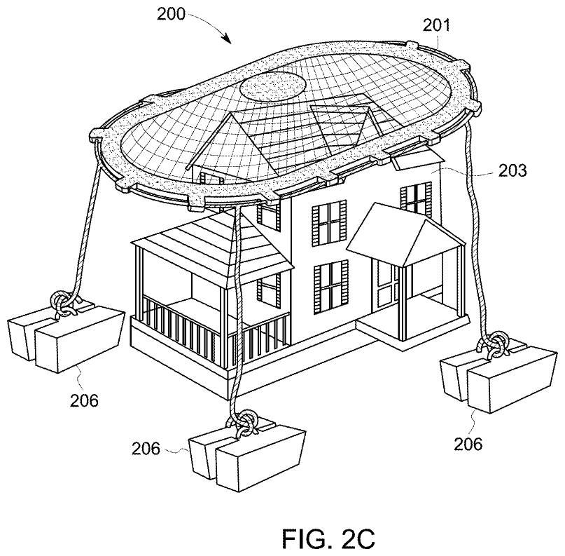

According to another exemplary embodiment of the invention, FIG. 2A, FIG. 2B and FIG. 2C refer to different use cases of application of the multipurpose floating weather canopy. The floating canopy 201 enables fastening to various exterior objects. The floating canopy 201 is fastened to a house 203 using ropes 202. The size of the floating canopy, ropes 202 and the mesh material of the floating canopy 201 are chosen based on the object to be protected, size of the object and the extreme weather condition to which the object is often exposed. In the current use case, the ropes 202 are fastened to external vertical members of the house 203. In the case of wooden houses, the floating canopy can be fastened to the concrete part of the house 203 such as concrete foundation 204 to avoid damage to wooden members of the house 203. In another use case, the floating canopy 201 is utilized to cover a car 205. The ropes 202 are fastened to the car 205 directly at the bottom. Further, the floating canopy 201 can also be fastened to temporarily deployed structures such as concrete blocks 206 positioned in ground near the house 203. Similarly, the concrete blocks 206 can be utilized to fasten or anchor the floating canopy 201 over desired outdoor objects.

Numerous advantages of the present disclosure may be apparent from the discussion above. In accordance with the present disclosure, the multipurpose floating weather canopy is designed based on object size that includes either house or vehicle or factory and thereof. The size of the multipurpose canopy can be varied based on the requirement and size of the object to be protected. The multipurpose floating weather canopy can be manufactured with required mesh material to protect from heat or snow based on the weather condition.

The multipurpose floating weather canopy can be fastened to the object using different types of knots or hooks or other fastening techniques. The floating canopy can be fastened directly to the object itself or nearby solid objects such that the floating canopy covers the object. The multipurpose floating weather canopy comprises plurality of partitions inside each hollow body to enable easy folding whenever the gas is removed from the inner and outer hollow bodies. The inner gas tight hollow body and the outer gas tight hollow body are filled with gases that are lighter than air such as helium gas or nitrogen gas and thereof.

The embodiments described above are intended only to illustrate and teach one or more ways of practicing or implementing the present invention. The invention is not intended to restrict to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various form or modifications in which the invention might be embodied or operated.

It will readily be apparent that numerous modifications and alterations can be made to the processes described in the foregoing examples without departing from the principles underlying the invention, and all such modifications and alterations are intended to be embraced by this application.

I claim:

1. A multipurpose floating weather canopy, comprising:
an inner gas tight hollow body configured to float above an object;
an outer gas tight hollow body configured to surround said inner gas tight hollow body with a certain offset and extended with plurality of fastening guides on peripheral surface of outer gas tight hollow body, wherein said outer gas tight hollow body is configured to float along with said inner gas tight hollow body;
a mesh connected in between said inner gas tight hollow body and said outer gas tight hollow body and configured with plurality of mesh threads to protect the object from extreme weather conditions; and
plurality of ropes peripherally connected to said outer gas tight hollow body through said plurality of fastening guides and extended to ground for fastening,
whereby said multipurpose floating weather canopy aids to protect exterior objects from adverse weather conditions such as sunlight or snow.

2. The multipurpose floating weather canopy as recited in claim 1, wherein said inner gas tight hollow body is either in spherical or discoidal or cubical or cuboidal or triangular prism shape.

3. The multipurpose floating weather canopy as recited in claim 1, wherein said outer gas tight hollow body is in either elliptical or circular or rectangular shape.

4. The multipurpose floating weather canopy as recited in claim 1, wherein said outer gas tight hollow body and said inner gas tight hollow body are inflated with gases that are lighter than air and float together to protect the object from extreme weather such as snow and sunlight.

5. The multipurpose floating weather canopy as recited in claim 4, wherein said outer gas tight hollow body and said inner gas tight hollow body are inflated with helium gas.

6. The multipurpose floating weather canopy as recited in claim 1, wherein said multipurpose floating weather canopy is designed based on object size that include either house or vehicle or factory and thereof.

7. The multipurpose floating weather canopy as recited in claim 1, wherein said mesh is made of either thermally insulating materials or other materials that protect from sunlight or snow and enable easy cleaning.

8. The multipurpose floating weather canopy as recited in claim 1, wherein area of said mesh is limited to maintain optimal cost of said multipurpose floating weather canopy.

9. The multipurpose floating weather canopy as recited in claim 1, wherein said plurality of ropes are configured to pass through said plurality of fastening guides and enable fastening of said multipurpose floating weather canopy.

10. The multipurpose floating weather canopy as recited in claim 1, wherein said plurality of ropes extended are fastened to the ground that contains strong basement which contains either a temporarily deployed structure or a permanent deployed structure.

11. The multipurpose floating weather canopy as recited in claim 9, wherein said plurality of ropes extended are fastened to said strong basement using additional fastening elements.

12. The multipurpose floating weather canopy as recited in claim 1, wherein said inner gas tight hollow body and said outer gas tight hollow body each comprise at least one valve that aids to retain gas inside them.

13. The multipurpose floating weather canopy as recited in claim 1, wherein said mesh is a multi-layered mesh.
